(19) United States
(12) Patent Application Publication
(10) Pub. No.: US 2004/0118256 A1
(43) Pub. Date: Jun. 24, 2004

(54) Edge trimmer

(75) Inventor: Hans Prinzen, Monchengladbach (DE)

Correspondence Address: WILLIAM COLLARD, COLLARD & ROE, P.C., 1077 NORTHERN BOULEVARD, ROSLYN, NY, 11576, US

(73) Assignee: A. Monforts Textilmaschinen GmbH & Co.

(21) Appl. No.: 10/728,515

(22) Filed: Dec. 5, 2003

(30) Foreign Application Priority Data
Dec. 21, 2002 (DE) 102 60 554.8

(51) Int. Cl. B26D 3/00; B26D 1/00

(52) U.S. Cl. 83/13

(57) ABSTRACT

A method for monitoring the removal of a selvedge cut off from the edge of a textile fabric web, at the exit from a stretcher frame has means for removing, particularly vacuuming away, the cut-off selvedge and means for monitoring the removal. In order to prevent the possibility that the selvedge is drawn back into the machine counter to the vacuum direction, the selvedge is passed over an easily moved wheel, in such a manner that the wheel is necessarily entrained by the transported selvedge. The direction of rotation of the wheel is detected.

### BACKGROUND OF THE INVENTION

1. Field of the Invention

The invention relates to a method and device for monitoring the removal of a selvedge cut off from the longitudinal edge of a textile fabric web, at the exit from a stretcher frame. In particular, the invention relates to a method and device for vacuuming away the cut-off selvedge and for monitoring the removal.

2. The Prior Art

Stretcher frames are described in the DE book: W. Bernard, “Appretur der Textilien” (Finishing of textiles), Springer Verlag 1967, particularly 112 ff. The goods are passed through a heated space under lengthwise and crosswise tension in the stretcher frame. If necessary, edge trimmers can be provided on both sides of the fabric web at the exit from the stretcher frame.

German Patent No. DE 38 34 572 A1 describes an edge trimmer for cutting off the selvedges of fabric webs. In the known device, the fabric web is guided through the stretcher frame under crosswise tension, via a tension chain provided with needle strips, tenter hooks, or the like. The edge trimmer is located at the exit from the machine, at a location at which the needles are removed from the fabric web. The fabric web selvedge that is cut off, in each instance, is drawn out of the region of the cutting device and, at the same time, out of the region of the stretcher frame chain, using a flexible vacuum hose, and removed from the danger area by way of a hose or pipe system.

The cut-off selvedge slips out of the vacuum nozzle being used, for example, because the selvedge was not completely cut off. In this connection, it must be considered that the selvedge to be cut off from the fabric web is generally connected in and of itself, i.e., it often has the same length as the entire fabric web. If the strip is not seized by the vacuum nozzle at any moment during operation of the machine in question, and/or if it does not get into the removal system, the selvedge may run into the tension chain and be caught up there. In order to prevent such an accident, a photo eye or a similar monitoring means, which determines whether or not the cut-off selvedge has passed through the vacuum nozzle and the subsequent transport system, is provided in the vacuum nozzle. If the selvedge is not properly removed at any moment during operation of the machine, this error is detected by the photo eye, and reported, so that generally, the machine will automatically be stopped.

However, the aforementioned photo eye can only determine whether or not the cut-off selvedge is being transported by the vacuum system. The photo eye cannot determine the transport direction.

If the vacuum means loses the selvedge because it was not properly cut off from the fabric web in question, the selvedge pieces that were already vacuumed away can be drawn back out of the selvedge collection system, because the web continues to run in the machine, without the photo eye system being able to detect this error. The photo eye only registers whether or not a selvedge is present, and a selvedge drawn in the wrong direction is also registered as being present. Often, the machine operator will also not notice such an error in timely manner, because he relies on the report of the photo eye in question, that the cut-off selvedge is passing through the vacuum system. In such a case, the selvedge drawn back from the selvedge collector can be drawn through the entire machine length, for example 30 meters, and jammed into the transport chain, until the operator finally notices this defect. The repair expense will accordingly be huge.

### SUMMARY OF THE INVENTION

It is therefore an object of the invention to create a monitoring system for an edge trimmer of a stretcher frame that not only checks the transport of the cut-off selvedge in and of itself, but also the direction of the selvedge transport, and informs the machine operator in case of a malfunction, or shuts the machine down.

The invention consists of the fact that the cut-off (interconnected) selvedge glides over an easily moved wheel that is entrained, i.e., rotated, by the transported selvedge, and the direction of rotation of the wheel is detected. For the device for implementing the method, the solution consists of the fact that an easily moved wheel is arranged within a vacuum pipe in such a manner, and that the selvedge is laid on the wheel periphery in such a manner that the cut-off selvedge necessarily entrains the wheel, in other words turns it, particularly by means of gravity. Some improvements and other embodiments of the invention are indicated in the dependent claims.

With the invention, a monitoring system for removal of the cut-off selvedge is created, which not only checks for the presence or absence of a selvedge in the monitoring region, as a conventional photo eye does, but also checks the movement direction of the selvedge. The wheel entrained by the transported selvedge, i.e. the detector wheel, is coupled with a detector that determines the direction of rotation of the wheel and gives off an alarm signal if the wheel is turning in the “wrong” direction, i.e., if the selvedge is being drawn back out of the selvedge collector, or preferably shuts the machine down automatically. Of course, the wheel according to the invention can also give off an alarm as well as preferably shut the machine down if the wheel is not being entrained at all, either because the selvedge is not running over the wheel properly, or because no selvedge is being removed at all.

Preferably, the detecting wheel is mounted so that it moves as easily as possible, so that it can be set into motion by the selvedge that runs over the wheel or over its periphery. This entrainment effect can be brought about by the tensile force that acts on the cut-off selvedge on the basis of the vacuum effect and/or by the gravity effect that acts on the cut-off selvedge.

The detector wheel according to the invention can be used alone or in interaction with conventional photo eyes. Since the wheel also registers the transport direction of the cut-off selvedge, the possibility that the cut-off selvedge becomes caught in the stretcher frame chain is precluded when using the invention.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic view of parts of one side of the exit region of a stretcher frame.

### DETAILED DESCRIPTION OF THE PREFERRED EMBODIMENT

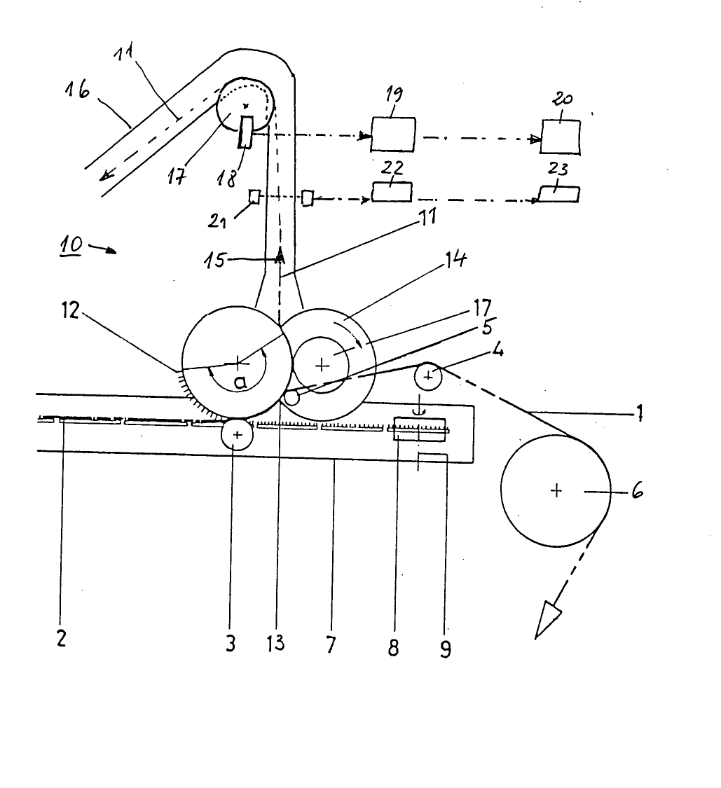

In FIG. 1, parts of one side of the exit region of a stretcher frame are shown schematically. The textile fabric web 1, which is being transported from left to right in the direction of the arrow, comes from a stretcher frame chamber (not shown), held at the edge in needle strips 2, is removed from the needles using rollers 3 and 4 and, if applicable, a rod 5 located between them, and continues to run in the direction of the arrow by way of a pull-out roller 6. The needle strips 2 are generally guided in chains in the stretcher frame, which chains extend on both sides of the fabric web 1 in chain boxes 7 and run over a deflection wheel 8, which (as shown) can have a vertical axis 9, at the lengthwise ends, in each instance.

If the selvedge of fabric web 1 is supposed to be cut off at the exit from the stretcher frame, an edge trimmer device indicated as a whole as 10 is provided there. This device is designed so it reliably removes the cut-off selvedge 11 from the region of the fabric web 1 that is being transported further, for example even if a seam is present. For this purpose, fabric web selvedge 11 is already captured using a needle roller 12 or the like, even before selvedge 11 is cut off.

After selvedge 11 has been captured by needle roller 12, fabric web 1, still in one piece with its selvedge 11, reaches cutting site 13 of a cutting blade 14, which is circular, for example. This blade can interact with part of needle roller 12, if needle roller 12 has a counter-blade. Selvedge 11, which is cut off from fabric web 1 at cutting site 13, goes to a collection site (not shown) in vacuum direction 15, through a vacuum pipe 16.

According to the invention, selvedge 11, which is essentially formed as a continuous strip, is passed over an easily moved wheel 17 on its way through vacuum pipe 16, in such a manner that wheel 17 is necessarily entrained by transported selvedge 11, in the transport direction of selvedge 11. The wheel 17 has a detector 18 assigned to it, which registers the direction of rotation of the wheel, preferably also the fact that the wheel is turning at all. Detector 18 can be coupled with a signal emitter 19, which gives off an optical and/or acoustical alarm if wheel 17 is turning counter to vacuum direction 15, preferably also if the wheel is not moving at all. Signal emitter 19 can also be connected with a switch 20 that automatically shuts down the machine in the case of a malfunction determined using detector 18.

In addition to detector wheel 17 according to the invention, a conventional photo eye 21 can be assigned to vacuum pipe 16, which registers whether or not there is a selvedge 11 in vacuum pipe 16. If photo eye 21 does not detect a selvedge 11, it can give off an alarm, by way of an optical and/or acoustical signal emitter 22, and/or automatically shut down the machine by way of a switch 23.

Accordingly, while only a few embodiments of the present invention have been shown and described, it is obvious that many changes and modifications may be made thereunto without departing from the spirit and scope of the invention.

Reference Symbol List:

1=textile fabric web

2=needle strip

3=roller

4=roller

5=rod

6=pull-out roller

7=chain box

8=deflection wheel

9=axis (8)

10=edge trimmer device

11=selvedge

12=needle roller

13=cutting site

14=cutting blade

15=vacuum direction

16=vacuum pipe

17=wheel

18=detector

19=signal emitter

20=switch

21=photo eye

22=signal emitter

23=switch

What is claimed is:

1. A method for monitoring the removal of a selvedge cut off from an edge of a textile fabric web, at the exit from a stretcher frame, said frame having means for vacuuming away the cut-off selvedge and means for monitoring the removal, the method comprising the steps of:
passing the selvedge over an easily moved wheel that is entrained by the transported selvedge, and
detecting a direction of rotation of the wheel.

2. A device for monitoring the removal of a selvedge cut off from the edge of a textile fabric web, at the exit from a stretcher frame, comprising:
a device for vacuuming away the cut-off selvedge;
a device for monitoring removal of the selvedge; and
an easily moved wheel arranged within a vacuum pipe so that the selvedge is laid on a periphery of the wheel and entrains the wheel.

3. A device according to claim 2, wherein the wheel has a detector for registering a direction of rotation of the wheel.

4. A device according to claim 3, wherein the detector is assigned to an optical or acoustical signal emitter and/or a switch for shutting down the stretcher frame.

5. A device according to claim 2, wherein a photo eye for registering the presence or absence of a cut-off selvedge is assigned to the vacuum pipe, in addition to the easily moved wheel.
